(19) United States
(12) Patent Application Publication
(10) Pub. No.: US 2004/0030418 A1
(43) Pub. Date: Feb. 12, 2004

(54) Simulation system for machine simulation and data output of control data for an automation system

(75) Inventors: Carsten Hamm, Erlangen (DE); Karl-Heinz Maier, Nurnberg (DE)

Correspondence Address: Henry M. Feiereisen, Suite 4714, 350 Fifth Avenue, New York, NY, 10118, US

(73) Assignee: Siemens Aktiengesellschaft, Munchen (DE)

(21) Appl. No.: 10/619,759

(22) Filed: Jul. 14, 2003

(30) Foreign Application Priority Data
Jul. 12, 2002 (DE) 102 31 675.9

(51) Int. Cl. G05B 13/02

(52) U.S. Cl. 700/30

(57) ABSTRACT

A system and method are described for constructing and/or designing/planning/programming a production and/or processing machine. The various construction phases are executed within the system by an iterative process, whereby the simulation data of a mechanical model of the machine are used for designing/planning/programming a controller and/or a drive. The effect of the controller on the performance of the mechanical model is checked again in a subsequent step. In this way, the entire system which includes the machine and the controller software as well as the drive, is optimized step-by-step, resulting in an integrated design from the mechanical components to the software.

### CROSS-REFERENCES TO RELATED APPLICATIONS

This application claims the priority of German Patent Application, Serial No. 102 31 675.9, filed Jul. 12, 2002, pursuant to 35 U.S.C. 119(a)-(d), the disclosure of which is incorporated herein by reference.

### BACKGROUND OF THE INVENTION

The present invention relates to a system and a method for simulating production and/or processing machines and for process design/planning/programming of a controller and/or a drive.

In order to satisfy the requirement for increased efficiency in the production of goods, the production and/or processing machines used in production have to assume more and more specialized tasks. Accordingly, the construction of the machines is more specialized so that they can satisfy these different requirements. As a result, a greater number of new machines has to be designed. Production and/or processing machines consist generally of a mechanical part, electro-technical equipment, a controller and a control software. The drive, i.e., the power supply and the electric motor, is typically added to the controller of the machine. When a specific production machine is designed, these components are typically designed independent of each other. A sequential design has, for example, the following form: at an operator console, a mechanical configuration of the machine is designed with the help of CAD systems. The mechanical system of the machine is subsequently designed based on the CAD data. The electro-technical equipment matching the mechanical design of the machine is then designed and the hardware necessary for controlling the machine and for processing and/or reading the process data is selected. The machine controller, which is selected depending on the complexity of the machine to be operated, is connected to and placed in the service together with the associated electro-technical components. Modern machines operate with a program that is specifically adapted to the requirements on the machine and the application. Various software solutions which support the designer in the aforementioned development phases already exist for the individual assembly or fabrication steps of the production machine. The development phases are presently executed sequentially, whereby the machine, i.e., the mechanical part, determines the layout of the electro-technical parts and the implementation of controller. This sequential approach results in relatively long development times for such machines, and the subsequent development phases, such as planning the electro-technical equipment, the selection of the drives and the development of the controller, are tied to the mechanical design requirements. In addition, information required for the individual development phases is presently still transmitted in paper form. Simulation tools are used in addition to the software support, such as the CAD systems, for the construction of machines. Machine-specific parameters can hereby be changed in a model, and the result of such changes on the overall machine characteristic can be simulated. Such simulation tools are typically also limited to the individual construction phases.

It would therefore be desirable and advantageous to provide a system and a method which enables an integrated design of production and/or processing machines, which obviates prior art shortcomings and is able to specifically match the mechanical parts-as well as the controller of the machine to each other early in the design process.

### SUMMARY OF THE INVENTION

According to one aspect of the invention, a system for simulating a production and/or processing machine includes a first device for setting up at least one mechanical model of the machine, a simulator for performing a mechanical simulation of the machine as well as for supplying simulation data, and a second device for setting up a model of a controller and/or drive for the machine based on the simulation data. Accordingly, an understanding of the mechanical properties of the production machine, which are gained based on the mechanical model and a subsequent simulation, can be used in such system in the early stages for designing the controller and the drive. Variables which are already available in the mechanical model, and which are relevant for the controller and/or drive design, can be used early on. If the mechanical construction is implemented in such a way that the controller and/or drive design encounters problems, then the problems can be recognized in a timely manner and perhaps eliminated, unlike in the individual development phases of a sequential process. In addition, the system enables an advantageous information flow between the individual construction phases, since all the required data are available within the system, so that no data have to be transmitted in paper form.

According to another aspect of the invention, a method for simulating a production and/or processing machine includes the steps of generating a mechanical model of the machine, performing a mechanical simulation of the machine to generate simulation data, and generating a model of a controller or drive for the machine based on the simulation data.

According to yet another aspect of the invention, a computer program, residing on a computer-readable medium, is provided for simulating a production and/or processing machine, with the program including instructions for causing a computer to generate a mechanical model of the machine, to perform a mechanical simulation of the machine to generate simulation data, and to generate a model of a controller or drive for the machine based on the simulation data.

According to one advantageous feature of the invention, the system is adapted to design/plan/program the controller and/or drive of the machine. On the basis of the simulation data that exist in the mechanical model, the entire cycle for designing the controller and the drive can be executed. The design process can be executed within a system from the start of the design of the associated components to the programming of software for controlling the machine. This approach simplifies planning and fabrication, since the same database is always employed, eliminating data transfer between the different systems. In addition, a uniform interface can be used which eliminates the need for training on different systems.

According to another advantageous feature of the invention, the first device is adapted to set up mechanical models of the machines as a graphic representation, which makes it much easier for a mechanical engineer to construct a machine. The engineer can use the display to assemble, add and exchange the components required for the machine, while being able to observe the mutual interaction between the comportments. This provides a visual model of the machine to be constructed.

According to another advantageous embodiment of the invention, the second device is implemented as an engineering system. The drives and/or the controls can hereby designed/planned/programmed in a conventional setting using conventional tools. This obviates the need for substituting equipment which is already being used for process design/planning/programming. The new system can therefore save costs by using available engineering systems.

According to another advantageous feature of the invention, a third device is provided that generates at least one computer program for controlling the production and/or processing machine based on the controller and/or drive model. The controls planned in the system can then be directly implemented based on the mechanical model or the mechanical simulation. The engineering data can be used to generate, for example, sections of application software which are then executed under control of the runtime software. This simplifies project planning/programming.

According to another advantageous feature of the invention, the system includes a graphic display. The parameters calculated in the mechanical simulation are hence not only used directly for setting up a model for the controller and/or the drive, but they can also be represented in the form of, for example, curves. Such representation has the advantage that the engineer can directly view the performance of the parameters. Changes of, for example, the force, mass, motion or energy in the simulation of the machine motion is then represented together with the associated measurement units. An engineer can then immediately recognize if certain quantities exceed, for example, threshold values or if the entire system shows destructive behavior.

According to another advantageous feature of the invention, the second device transmits data of the models that are set up by the second device, to the first device, which then generates an updated model based on the data of the control or drive models, which is in turn used to have the simulator repeat a mechanical simulation. The feedback between the device which is provided for the project design/planning/programming of the controller and/or drives, as well as the device which is provided for constructing the mechanical model, enable a mutual interaction between the respective models. Characteristic properties of the controller and the drive, for example the torque of a motor or its weight, affect the mechanical characteristics of the machine. In the aforedescribed embodiment of the invention, these data can be directly taken into account in the mechanical model and thereby in the mechanical simulation. At the same time, this feedback loop can be used for a simple solution if specific characteristic properties of the mechanical model are observed to cause problems in the controller and/or drive design. Parameters of the controller or drive design can be changed to that the problems can be circumvented. It can subsequently be tested in the mechanical model if these changes have a detrimental effect on the operation of the machine or if the effect caused by these changes can be neglected. The iterative approach with stepwise adaptation of the two models accelerates the development and improves the match between the mechanical components and the associated controls and drives. Such co-simulation of the mechanical elements and the controller and drives improves the development of the machines.

According to another advantageous feature of the invention, a memory is provided for storing information data for hardware components of the machine. In addition to the purely mechanical components which are modeled in the system, the production machines also include electronic, electro-technical and electromechanical components, such as motors, transducers or sensors. These components affect the performance of the mechanical model and subsequently also the machine performance. For example, inertia or switching times of the components have to be taken in consideration during the design phase. Advantageously, the device for setting up a mechanical model can include a library with information about the respective components, which the device can access. If specific components are introduced into mechanical model, then their characteristic properties and the mutual interaction with the other components can also be simulated. In addition, variables associated with the characteristic properties can advantageously be used for designing/planning/programming the controller/drive. The availability of such library simplifies the description of the properties of the components in individual situations, which speeds up the design.

According to another advantageous feature of the invention, the stored information data are provided in form of objects representing the corresponding hardware components. The information data are thereby not individually stored in memory and need not be assembled when selecting a particular component.

According to another advantageous feature of the invention, the objects assist the first device in setting up the mechanical model. All relevant data associated with a specific component are directly linked to this component, and the data are automatically introduced into the mechanical model when selecting the corresponding component. Such approach simplifies and accelerates project engineering of the mechanical model.

According to another advantageous feature of the invention, an additional memory for storing images of the objects is provided on the second device. Since the components mentioned above, such as motors, transducers or gears, do not only affect the performance of the mechanical model, but also the performance of the controller, these objects are advantageously also available, together with their characteristic properties, in the project design/planning/programming of the controller/drive. All components can be selected when the mechanical model is set up, as well as during the project design/planning/programming of the control/drive. The components are subsequently evaluated in the simulation with respect to their performance in the entire system. With the visualization of the objects, both devices can make use of the same basic features even if the required information data associated with the respective objects are different.

According to another advantageous feature of the invention, the second device uses semantic contained in the information data to generate a computer program. The information data are stored in the memory in form of objects, and can therefore be used in a simple manner for generating software. The objects have characteristic properties and/or attributes and methods. A drive attribute can include, for example, the position of the drive inside the machine, whereas a drive method can include, for example, the acceleration. For generating software, the attributes can be represented in form of variables and the methods in form of procedures. This ensures a simple and integrated conversion from the individual hardware components to generating the controller software.

According to another advantageous feature of the invention, the first device and the second device use the same variable names. This simplifies matching the respective systems to each other. The designers who accompany the different construction phases, can thereby more easily communicate with each other, thereby harmonizing the entire construction process.

According to another advantageous feature of the invention, the system receives data from and/or transmits data to the machine via an intranet and/or the Internet. Such data transmission can advantageously be used for analyzing runtime software which is executed, for example, on a machine at a remote location and which requires functionality checks. The corresponding runtime software can be loaded onto the system via the Internet and its performance can be simulated in conjunction with a mechanical model associated with the production machines. The software can then be adapted in the system and transmitted back to the remote production machines via the Internet. The features of the invention advantageously enable remote servicing of the software of production machines.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of a system for simulating a production machine and for project design/planning/programming of a controller and/or a drive for the production machine in accordance with the present invention; and

FIG. 2 is a schematic diagram of the transmission of software via an intranet and/or the Internet.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

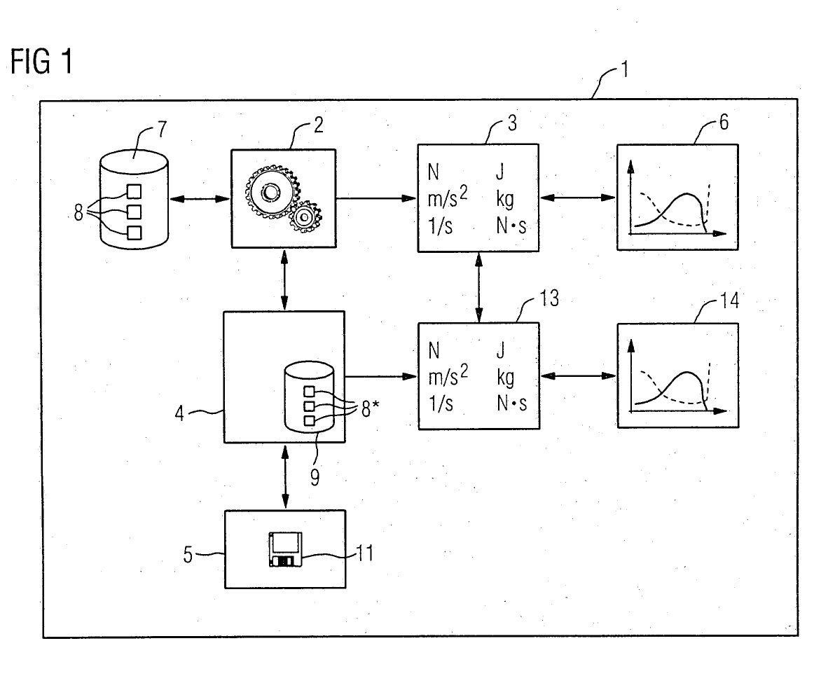

Turning now to the drawing, and in particular to FIG. 1, there is shown schematically an embodiment of an integrated system for simulating production and/or processing machines and for project design/planning/programming of the controller and/or drive for the production and/or processing machines. The system 1 includes a first unit 2 which can be used to set up a mechanical model of a production machine, typically in form of a graphic model of the production machine. The system 1 further includes a mechanical simulator 3 capable of performing a mechanical simulation of the corresponding mechanical model of the production machine. Hereby, characteristic properties such as force, mass, motion and energy of the respective production machine are simulated and provided in form of simulation data which are transmitted to the control simulator 13 for performing a control and/or drive simulation. The values calculated by the control simulator 13 form the basis for designing, for example, the drives and for configuring the controller for a second device 4, which is used to set up a control and/or drive model for the corresponding production and/or processing machine. Control software for the production and/or processing machines is produced by a third device 5 that the produces a computer program. The simulation data of the mechanical simulation can be displayed with the help of a graphic display 6 in the form of, for example, curve sections. The variables computed during the simulation are represented with the corresponding measurement units parallel to the motion of the corresponding machine. The simulation data for the controller and/or the drives can be viewed on a graphic visualization display 14. The simulator 13 can also be operated via the visualization display 14 by entering new data and subsequently simulating the resulting changes. Hardware components required for the production machine, for example different motors, are stored in a memory 7 in the form of objects 8 and can be used by the first unit 2 to generate a mechanical model. Images 8* of the respective hardware components are also stored in a memory 9 in the form of objects on the second device 4 and can be used by the second device 4 for process design/planning/programming.

According to an advantageous features of the embodiment of the system 1 depicted in FIG. 1, the initial design of the mechanical elements of the production machine, the selection of the associated electro-technical components, the project design/planning of the respective drives as well as programming the controller for the automation system are combined in the same system 1. Designing the controller and/or the drive depicted in FIG. 1 with the help of the second device 4 based on the mechanical model generated by the first device 2 has the advantage that certain variables of the model are already available during the design of the mechanical model, which affect of the operation of the system 1 and should therefore be used for designing the controller and/or drive. Conversely, the characteristic properties of the controller and/or the drives also affect the mechanical performance of the machine. The mutual interaction between the mechanical system and the controller is advantageously recognized by the system 1 of the invention, because the entire machine including the controller can be optimized by a mutual adaptation of the corresponding models. The data derived from the mechanical simulation can be directly used for designing the controller. Among the data are, for example, parameters which are relevant for selecting the hardware. Based on the measurement value from the simulation it can, for example, be determined which motor is required for a certain motion and/or acceleration. In addition, data are available which are relevant for parameterizing the respective hardware. These data include, for example, the number of digital inputs and outputs required for a specific production machine. Additional parameters relevant for the controller are, for example, the delay times of switches, sampling times or the number of movements which the machine has to perform within a certain time interval. These data form an important basis for planning/programming a controller for a corresponding automation system. The data generated by the simulation can be graphically displayed to the designer on the graphic display 6. For example, movements of a reference point or forces can be displayed in curve form. The curves can also directly indicate if particular forces are sufficient or excessive in the context of the proposed design. It can also be realized if pivoting motions of lever arms of the machine are excessive, violating safety zones or prohibited machining paths.

If a mechanical model is setup by the first device 2 using the hardware components stored in memory 7 in the form of objects 8, then all characteristic properties, such as movements of the mechanical model, are simulated by the simulator 3. The corresponding simulation data are used by the control simulator 13 to simulate a controller and/or drive for having the second device 4 set up a model for the controller. The system 1 therefore includes a model of the controller and/or the drives as well as a model of the mechanical setup of the machine. Both are simulated in parallel and the changes in one model are transferred at predetermined times to the other model, and the properties of the updated model are then tested again. The state variables computed by the machine simulation are supplied to the controller simulation, where they are processed further in the program. The computed control variables are then once more supplied to the mechanical model. In this way, the system features, from the mechanical features all the way to the software, can be designed in one pass. An integrated optimization of the complete facility and/or the machine, such as processing times, masses, forces and energy consumption, is possible with the system of the invention. The system of the invention therefore eliminates or at least ameliorates the disadvantages associated with sequential project design/planning of the electromechanical components and planning/programming of the controller, since both the control model as well as the mechanical model are adapted to each other step-by-step, which then optimizes the entire production process.

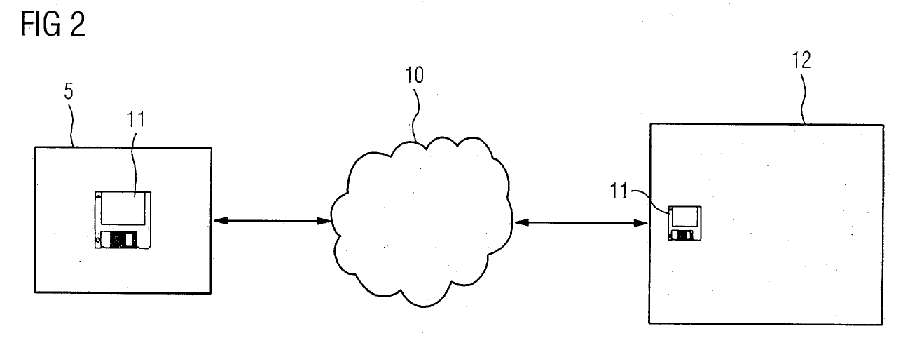

FIG. 2 is a schematic diagram for transmitting machine-specific control software 11 from a production and/or processing machine 12 to the system 1, wherein the transmission is implemented via an intranet and/or the Internet 10. The software is transmitted directly to the third device 5 which then generates a computer program.

More particularly, as depicted in FIG. 2, machine-specific runtime software 11 of a remote production and/or processing machine 12 can be transmitted to the system 1 without requiring additional copying and without transferring data carriers. The machine 12 and the system 1 only need access to an intranet and/or the Internet 10. By transmitting the data directly, the runtime software within the system can be checked via a simulation and tested on a mechanical model of the machine 12 stored in the system 1. The modified software can then be transmitted to back to the machine. In this way, the software can be easily remotely configured and/or serviced.

In summary, the invention is directed to a system 1 and a method for constructing and planning production and/or processing machines. The various construction phases are carried out within the system 1 by an iterative process. The simulation data of the mechanical model of a machine 12 are used for designing/planning/programming a controller and/or a drive. The effect of the planned/programmed controller on the performance of the mechanical model is checked in an additional step. As a result, of the entire system which consists of the machine and control software 11 as well as a drive, are optimized step-by-step, resulting in an integrated design from the mechanical characteristics to the software.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A system for simulating a production and/or processing machine comprising:
a first device for setting up at least one mechanical model of the machine;
a simulator for performing a mechanical simulation of the machine as well as for supplying simulation data; and
a second device for setting up a model of a controller or drive for the machine based on the simulation data.

2. The system of claim 1, wherein the system is adapted to design/plan/program the controller and/or drive of the machine.

3. The system of claim 1, wherein the first device is adapted to set up mechanical models of the machines as a graphic representation.

4. The system of claim 1, wherein the second device is implemented as an engineering system.

5. The system of claim 1, and further comprising a third device that generates a computer program for controlling the machine based on the model of the controller or drive.

6. The system of claim 1, and further comprising a graphic display for graphical illustration of the simulation data.

7. The system of claim 1, wherein the second device transmits data of the models that are set up by the second device, to the first device, which then generates an updated model based on the data of the control or drive models, which is in turn used to have the simulator repeat a mechanical simulation.

8. The system of claim 1, and further comprising a memory for storing information data for hardware components of the machine.

9. The system of claim 8, wherein the stored information data are provided in form of objects representing the corresponding hardware components.

10. The system of claim 9, wherein the objects assist the first device in setting up the mechanical model.

11. The system of claim 1, and further comprising an additional memory associated with the second device for storing images of the objects.

12. The system of claim 8, wherein the second device uses semantic contained in the information data to generate a computer program.

13. The system of claim 1, wherein the first device and the second device use the same variable names.

14. The system of claim 1, wherein the system receives data from and/or transmits data to the machine via an intranet and/or the Internet.

15. A method for simulating a production and/or processing machine, comprising the steps of:
generating a mechanical model of the machine;
performing a mechanical simulation of the machine to generate simulation data; and
generating a model of a controller or drive for the machine based on the simulation data.

16. The method of claim 15, and further comprising the step of designing/planning/programming the controller or drive for the machine.

17. The method of claim 15, and further comprising the step of generating a graphic visualization of the mechanical model of the machine.

18. The method of claim 15, wherein the model of the controller or drive is set up to an engineering system.

19. The method of claim 15, and further comprising the step of generating a computer program for controlling the machine based on the model of the controller or drive.

20. The method of claim 15, wherein the simulation data are graphically displayed.

21. The method of claim 15, and further comprising the steps of updating the mechanical model based on data transmitted from the controller or drive model, and repeating the mechanical simulation.

22. The method of claim 15, and further comprising the step of storing information data for hardware components of the machine.

23. The method of claim 22, wherein the information data are stored in form of objects that represent a corresponding hardware components.

24. The method of claim 23, wherein the mechanical model is generated based on the objects.

25. The method of claim 23, and further comprising the step of storing images of the objects in an additional memory associated with a device that generates the control and/or drive model for the machine.

26. The method of claim 22, and further comprising the step of generating a computer program based on the semantic contained in the information data.

27. The method of claim 26, wherein variable names used when generating the mechanical model are identical to variable names used when generating the computer program.

28. The method of claim 15, and further comprising the step of receiving and/or transmitting data via an intranet and/or the Internet.

29. A computer program,. residing on a computer-readable medium, for simulating a production and/or processing machine, the program comprising instructions for causing a computer to generate a mechanical model of the machine, perform a mechanical simulation of the machine to generate simulation data, and generate a model of a controller or drive for the machine based on the simulation data.
